(19) United States
(12) Patent Application Publication
(10) Pub. No.: US 2020/0250523 A1
(43) Pub. Date: Aug. 6, 2020

(54) SYSTEMS AND METHODS FOR OPTIMIZING AN ARTIFICIAL INTELLIGENCE MODEL IN A SEMICONDUCTOR SOLUTION

(71) Applicant: Gyrfalcon Technology Inc., Milpitas, CA (US)

(72) Inventors: Yongxiong Ren, San Jose, CA (US); Yequn Zhang, San Jose, CA (US); Baohua Sun, Fremont, CA (US); Xiaochun Li, San Ramon, CA (US); Qi Dong, San Jose, CA (US); Lin Yang, Milpitas, CA (US)

(73) Assignee: Gyrfalcon Technology Inc., Milpitas, CA (US)

(21) Appl. No.: 16/268,406

(22) Filed: Feb. 5, 2019

(51) Int. Cl. G06N 3/08; G06F 7/483; G06N 3/04

(52) U.S. Cl. CPC G06N 3/08; G06N 3/04; G06F 7/483

(57) ABSTRACT

In some examples, given an AI model in floating point, a system may use one or more artificial intelligence (AI) chips to train a global gain vector for use to convert the AI model in floating point to an AI model in fixed point for uploading to a physical AI chip. The system may determine initial gain vectors, and in each of multiple iterations, obtain the performance values of the AI chips based on the gain vectors and update the gam vectors for the next iteration. The gain vectors are updated based on a velocity of gain. The performance value may be based on feature maps of an AI model before and after the converting. The performance value may also be based on interference over a test dataset. Upon completion of the iterations, the system determines the global gain vector that resulted in the best performance value during the iterations.

### FIELD

This patent document relates generally to systems and methods for optimizing artificial intelligence solutions. Examples of optimizing an artificial intelligence model in a semiconductor solution are provided.

### BACKGROUND

Artificial intelligence solutions are emerging with the advancement of computing platforms and integrated circuit solutions. For example, an artificial intelligence (AI) integrated circuit (IC) may include a processor capable of performing AI tasks in embedded hardware. Hardware-based solutions, as well as software solutions, still encounter the challenges of obtaining an optimal AI model, such as a convolutional neural network (CNN). For example, if weights of a CNN model are trained outside the chip, they are usually stored in floating point. When weights in floating point are loaded into an AI chip they usually lose data bits, for example, from 16- or 32-bits to 5- or 8-bits. The loss of data bits in an AI chip compromises the performance of the AI chip due to lost information and data precision.

### BRIEF DESCRIPTION OF THE DRAWINGS

The present solution will be described with reference to the following figures, in which like numerals represent like items throughout the figures.

FIG. 1 illustrates an example system in accordance with various examples described herein.

FIG. 2 illustrates an example system of optimizing gains of AI models in accordance with various examples described herein.

FIG. 3 illustrates a diagram of an example process of converting an AI model in floating point to an AI model in fixed point in accordance with various examples described herein.

FIG. 4 illustrates a diagram of an example process of obtaining optimized gains in accordance with various examples described herein.

FIG. 5 illustrates various embodiments of one or more electronic devices for implementing the various methods and processes described herein.

### DETAILED DESCRIPTION

As used in this document, the singular forms “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.” Unless defined otherwise, all technical and scientific terms used in this document have the same meanings as commonly understood by one of ordinary skill in the art.

Each of the terms “artificial intelligence logic circuit” and “AI logic circuit” refers to a logic circuit that is configured to execute certain AI functions such as a neural network in AI or machine learning tasks. An AI logic circuit can be a processor. An AI logic circuit can also be a logic circuit that is controlled by an external processor and executes certain AI functions.

Each of the terms “integrated circuit,” “semiconductor chip,” “chip,” and “semiconductor device” refers to an integrated circuit (1C) that contains electronic circuits on semiconductor materials, such as silicon, for performing certain functions. For example, an integrated circuit can be a microprocessor, a memory, a programmable array logic (PAL) device, an application-specific integrated circuit (ASIC) or others. An integrated circuit that contains an AI logic circuit is referred to as an AI integrated circuit.

The term “AI chip” refers to a hardware- or software-based device that is capable of performing functions of an AI logic circuit. An AI chip can be a physical IC. For example, a physical AI chip may include an embedded cellular neural network (CeNN), which may contain parameters of a CNN. The AI chip may also be a virtual chip, i.e., software-based. For example, a virtual AI chip may include one or more processor simulators to implement functions of a desired AI logic circuit of a physical AI chip.

The term of “AI model” refers to data that include one or more weights that are used for, when loaded inside an AI chip, executing the AI chip. For example, an AI model for a given CNN may include the weights and or parameters for one or more convolutional layers of the CNN. Here, the weights and parameters of an AI model are interchangeable.

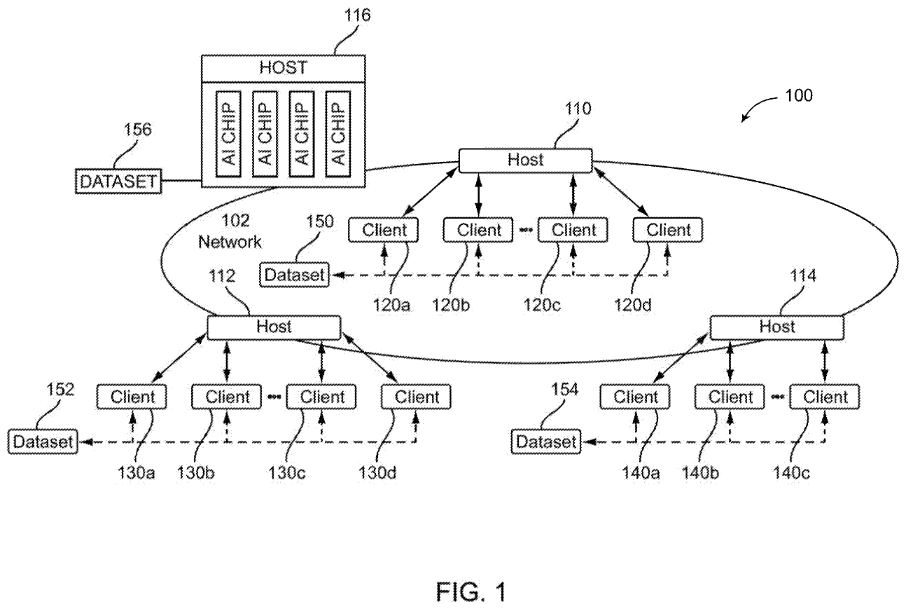

FIG. 1 illustrates an example system in accordance with various examples described herein. In some examples, a communication system 100 includes a communication network 102. Communication network 102 may include any suitable communication links, such as wired (e.g., serial, parallel, optical, or Ethernet connections) or wireless (e.g., Wi-Fi, Bluetooth, or mesh network connections), or any suitable communication protocols now or later developed. In some scenarios, system 100 may include one or more host devices, e.g., 110, 112, 114, 116. A host device may communicate with another host device or other devices on the network 102. A host device may also communicate with one or more client devices via the communication network 102. For example, host device 110 may communicate with client devices 120a, 120b, 120c, 102d, etc. Host device 112 may communicate with 130a, 130b, 130c, 130d, etc. Host device 114 may communicate with 140a, 140b, 140c, etc. A host device, or any client device that communicates with the host device, may have access to one or more datasets used for obtaining an AI model. For example, host device 110 or a client device such as 120a, 120b, 120c, or 120d may have access to dataset 150.

In FIG. 1, a client device may include a processing device. A client device may also include one or more AI chips. In some examples, a client device may be an AI chip. The AI chip may be a physical AI 1C. The AI chip may also be software-based, i.e., a virtual AI chip that includes one or more process simulators to simulate the operations of a physical AI 1C. A processing device may include an AI 1C and contain programming instructions that will cause the AI IC to be executed in the processing device. Alternatively, and or additionally, a processing device may also include a virtual AI chip, and die processing device may contain programming instructions configured to control the virtual AI chip so that the virtual AI chip may perform certain AI functions. In FIG. 1, each client device, e.g., 120a, 120b, 120c, 120d may be in electrical communication with other client devices on the same host device, e.g., 110, or client devices on other host devices.

In some examples, the communication system 100 may be a centralized system. System 100 may also be a distributed or decentralized system, such as a peer-to-peer (P2P) system. For example, a host device, e.g., 110, 112, 114, and 116, may be a node in a P2P system. In a non-limiting example, a client devices, e.g., 120a, 120b, 120c, and 120d may include a processor and an AI physical chip. In another non-limiting example, multiple AI chips may be installed in a host device. For example, host device 116 may have multiple AI chips installed on one or more PCI boards in the host device or in a USB cradle that may communicate with the host device. Host device 116 may have access to dataset 156 and may communicate with one or more AI chips via PCI board(s), internal data buses, or other communication protocols such as universal serial bus (USB).

In some scenarios, the AI chip may contain an AI model for performing certain AI tasks, e.g., voice or image recognition tasks, or other tasks that may be performed using an AI model. In some examples, an AI model may include a forward propagation neural network, in which information may flow from the input layer to one or more hidden layers of the network to the output layer. For example, an AI model may include a convolutional neural network (CNN) that is trained to perform voice or image recognition tasks. A CNN may include multiple convolutional layers, each of which may include multiple weights and/or parameters. In such case, an AI model may include weights and/or one or more parameters of the CNN model. In some examples, the weights of a CNN model may include a mask and a scalar for a given layer of the CNN model. For example, a kernel in a CNN layer may be represented by a mask that has multiple values in lower precision multiplied by a scalar n higher precision. In some examples, an output channel of a CNN layer may include one or more bias values that, when added to the output of tire output channel, adjust the output values to a desired range.

In a non-limiting example, in a CNN model, a computation in a given layer in the CNN may be expressed by Y=w*X+b, where X is input data, Y is output data in the given layer, w is a kernel, and b is a bias. Operation “*” is a convolution. Kernel w may include binary values. For example, a kernel may include 9 cells in a 3×3 mask, where each cell may have a binary value, such as “1” and “−1.” In such case, a kernel may be expressed by multiple binary values in the 3×3 mask multiplied by a scalar. The scalar may include a value having a bit width, such as 12-bit or 8-bit. Other bit length may also be possible. By multiplying each binary value in the 3×3 mask with the scalar, a kernel may be used in convolution operations effectively in higher bit-length. Alternatively, and/or additionally, a kernel may contain data with n-value, such as 7-value. The bias b may contain a value having multiple bits, such as 12 bits or 20 bits. Other bit length may also be possible.

In the case of physical AI chip, the AI chip may include an embedded cellular neural network that has memory containing the multiple weights and/or parameters in the CNN. In some scenarios, the memory in a physical AI chip may be a one-time-programmable (OTP) memory that allows a user to load a CNN model into the physical AI chip once. Alternatively, a physical AI chip may have a random access memory (RAM) or other types of memory that allows a user to update and load a CNN model into the physical AI chip multiple times.

In the case of virtual AI chip, the AI chip may include a data structure that simulates the cellular neural network in a physical AI chip. A virtual AI chip can be of particular advantageous when multiple tests need to be run over various CNNs in order to determine a model that produces the best performance (e.g., highest recognition rate or lowest error rate). In a test run, the weights in the CNN can vary and be loaded into the virtual AI chip without the cost associated with a physical AI chip. Only after the CNN model is determined will the CNN model be loaded into a physical AI chip for real-time applications.

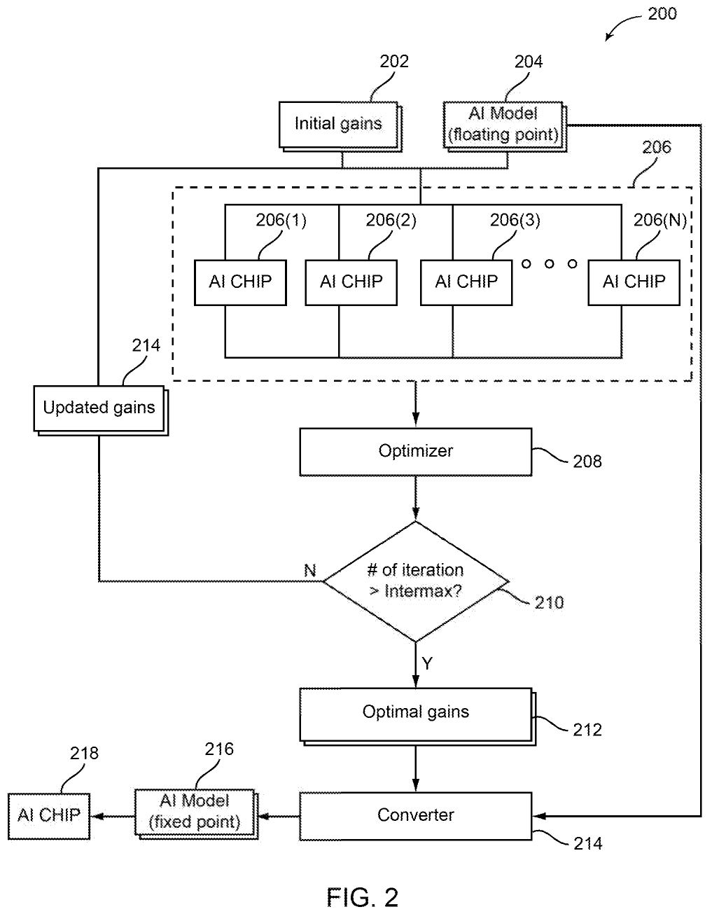

In some examples, the weights of an AI model for an AI chip may be trained partially on a computing system external to the AI chip to utilize the computing resources of the computing system. In such case, the weights of the AI model may be trained to be floating point, as opposed to fixed point that may be needed in a physical AI chip. In some examples, the trained weights in floating point may be directly downloaded to the AI chip, during which process weights in floating point will lost data precision or bit information from quantization, e.g., from 32 bits to 12 bits. In some examples, one or more gain values may be stored together with floating point and are used to convert the weights of the AI model from floating point to fixed point. For example, a gain vector including multiple gain values may be used to convert weights of an AI model from floating point to fixed point. In some examples, an AI model may include a CNN model that includes multiple convolution layers. In such case, the gain vector may be represented as G={g1, g2, . . . , gn}, where n equals the number of convolution layers in the CNN model. Each of the multiple gain values in the gain vector may be used for a corresponding convolution layer of the CNN model. In some examples, a gain value may be used by each layer, where the weights of the convolution layer are multiplied by the gain value, then the result of the multiplication may then be quantized from floating point to fixed point. In other words, if the trained AI model is represented by (w, b), then the AI model (w×g, b×g) is quantized. The multiplication of the gain value for a layer (or the gain vector for the AI model) may reduce the quantization error of each layer, such that the fixed point model performance can approach or approximate floating point model performance. In some examples, the gain vector may be obtained via an optimizer based on the AI model itself and the test data for a specific AI task. The details of the optimizer are further described in FIG. 2.

Returning to FIG. 1, a host device on a communication network as shown in FIG. 1 (e.g., 110) may include a processing device and contain programming instructions that, when executed, will cause the processing device to access a dataset, e.g., 150, for example, test data. The test data may be provided for use in training the AI model. In some examples, the AI model may be trained in other systems. Once the AI model is trained, the system in FIG. 1 may obtain the gain vector for the AI model using one or more client devices (e.g., 120a, 120b, 120c, 120d etc.), or using one or more AI chips (e.g., 116). The test data may be provided for use to obtain the gain vector for the AI model. In doing so, the gain vector may be trained “in tune” with the test data. For example, the same test data may be used for training an AI model that is suitable for face recognition tasks, and may contain any suitable dataset collected for performing face recognition tasks. In another example, test data may be used for training an AI model suitable for scene recognition in video and images, and may contain any suitable scene dataset collected for performing scene recognition tasks. In some scenarios, test data may be residing in a memory in a host device. In one or more other scenarios, test data may be residing in a central data repository and is available for access by any of the host devices (e.g., 110, 112, 114 in FIG. 1) or any of the client devices (e.g., 120a-d, 130a-d, 140a-d in FIG. 1) via the communication network 102. In some examples, system 100 may include multiple test sets, such as datasets 150, 152, 154. A gain vector may be obtained by using the multiple devices in a communication system such as shown in FIG. 1. Details are further described with reference to FIGS. 2-4.

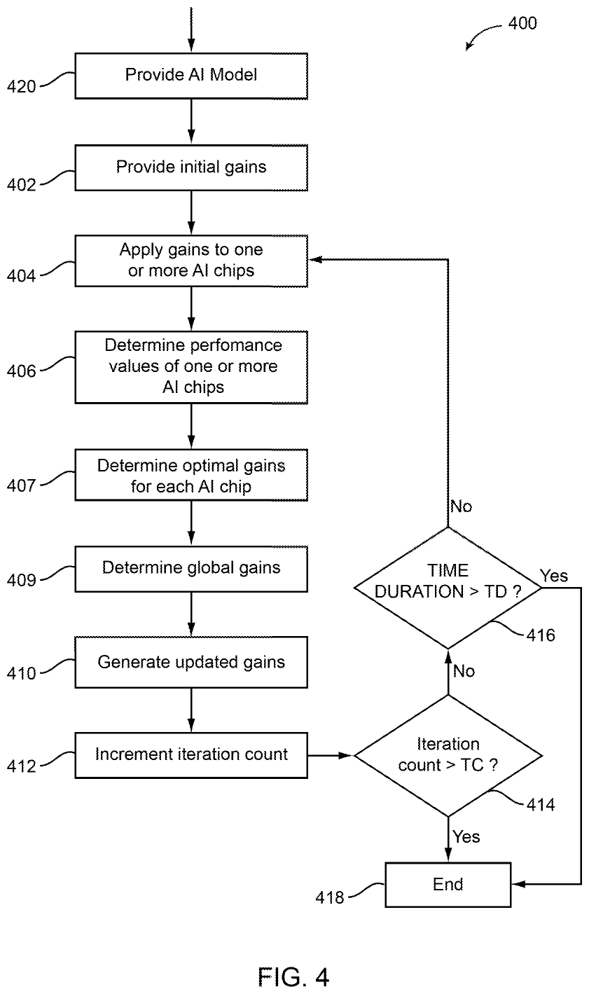

FIG. 2 illustrates an example system of optimizing gains of AI models in accordance with various examples described herein. In FIG. 2, a system 200 may include a device 206 that includes multiple AI chips 206(1), 206(2), . . . 206(N). The device 206 may also include at least a processing device (not shown), including a memory containing programming instructions that, when executed, cause the AI chips to execute an AI task based on a respective AI model in each of the AI chips. In some examples, the system 200 may be configured to cause the AI chips to optimize the gain vector. For example, each of the AI chips 206(1), 206(2), . . . 206(N) may be configured to receive initial gains 202 and the trained AI model 204 to execute and generate an output. The system 200 may also include an optimizer 208 configured to generate an updated gain vector based on the output of the AI chips. Optimizer 208 will further be described in detail in FIG. 4.

Returning to FIG. 2, an updated gain vector may be returned to each of the AI chips 206(1), 206(2), . . . 206(N) in device 206 iteratively. In each iteration, new output are determined by each of the AI chips 206(1 . . . N) based on the respective updated gain vectors for each AI chip, and the optimizer 208 may update the gain vector again based on the new output of the AI chips. The number of iterations may be checked at 210 to determine whether a maximum iteration number, e.g., IterMax, has been reached. If it is determined that the maximum iteration number has reached, the global gains 212 may be generated. In some examples, the system 200 may further include a converter 214 configured to convert an AI model in floating point (e.g., 204) to an AI model in fixed point (e.g., 216) using the global gains 212. The converted AI model in fixed point 216 will then be loaded into a physical AI chip 218 to perform AI tasks.

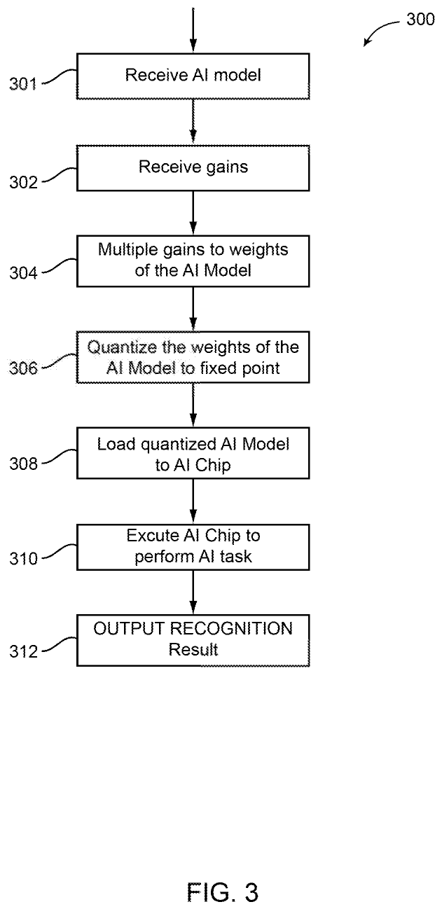

Now, FIG. 3 illustrates a diagram of an example process, e.g., 300, of obtaining optimized gains in accordance with various examples described herein. In some examples, the process 300 may be implemented in the converter (e.g. 214 in FIG. 2). The process 300 may receive an AI model in floating point at 301. The process may also receive gains at 302. In some examples, the AI model may be trained and stored in a memory. For example, the gains may be trained, such as described in FIG. 2, and will further be described in the disclosure. In some examples, the process 300 may multiply the gains to the weights of the AI model at 304. As shown in the example above, the AI model may include a CNN model comprising multiple convolution layers, each layer including multiple weights. In a non-limiting example, the gains may include a vector that includes multiple gain values. The process may multiply each of the multiple gain values to the weights in a respective convolution layer in the AI model. The process 300 may further quantize the weights of each of the convolution layers of the AI model to fixed point at 306. For example, the result of the multiplication of the weights and the gains can be quantized into 12-bit, which may be suitable for a physical AI chip. The process 306 may perform the quantization for each convolution layer of the AI model.

With further reference to FIG. 3, once the AI models are converted to fixed point the process 300 may load the AI model in fixed point to a physical AI chip at 308. In loading the AI model to the AI chip, the process may load one or more converted weights of the AI model to a corresponding memory location in the AI chip. The process may further execute the AI chip to perform an AI task at 310, and output the recognition result from the AI chip at 312. For example, a CNN model may be trained for face recognition tasks, and process 310 may cause the AI chip to perform various AI tasks using the trained weights and parameters. In an example application, a client device may feed an input image into the AI chip and receive a recognition result from the AI chip. In outputting the recognition result, the process 312 may generate information that indicates which classification the input belongs to. In a non-limiting example, the CNN model may be capable of recognizing one or more classes from an input image, such as a cry and a smile face. In an example application, an AI chip may be installed in a camera and store weights and parameters of the CNN model. The AI chip may be configured to receive a captured image from the camera, perform an image recognition task based on the captured image and stored CNN model, and output the recognition result. The camera may display, via a user interface, the recognition result. For example, if the CNN model is trained for face recognition. A captured image may include one or more facial images associated with one or more persons. The recognition result may include the names associated with each input facial image. The user interface may display a person's name next to or overlaid on each of the input facial image associated with the person.

FIG. 4 illustrates a diagram of an example process of obtaining optimized gains in accordance with various examples described herein. A process, e.g., 400, may obtain optimized gain vectors for uploading into one or more AI chips. At least part of the process 400 may be implemented in an optimizer, e.g., 208 in FIG. 2. In some examples, the process 400 may include providing an AI model at 420. The AI model may be already trained and stored in floating point. The process 400 may also provide initial gains at 402. The initial gains may include multiple initial gain vectors, each corresponding to one of the multiple AI chips. There may be various ways of obtaining initial gains. For example, the process may assign random values to each of the gain values in a gain vector. A random value may be selected from a range, such as 0-5, or 0-10, or any other suitable range. In another non-limiting example, the process may use test data to determine initial gains. For example, the initial gains in a gain vector may be the ratio of the capacity of the AI chip (for holding weights), e.g., 5 bits, over the maximum bit length of the input images. For example, if the majority of images in the test data tend to be dark, then gain values may be selected so that they can be used to scale up the input image values to maximally use the bit width of each layer of the AI chip. Other ways of obtaining initial gains are also possible.

With further reference to FIG. 4, the process 400 may start an iteration process, and increase an iteration counter at each iteration, at 412. In each iteration, the process 400 may apply the gains (or the initial gains at the start of the iteration) to one or more AI chips at 404. The multiple chips may be AI chips 206(1), . . . , 206(N) in FIG. 2, for example. For each of the multiple AI chips, the process may use the gains to convert the AT model in floating point to an AI model in fixed point, and load the AI model in fixed point to the AI chip, such as described in FIG. 3.

Returning to FIG. 4, once the AI model in fixed point are loaded into the one or more AI chips, the process may execute the AI chips and determine the performance values of the AI model in the one or more AI chips at 406. For an AI model, an associated performance value indicates how well the AI model performs when it is used in an AI task, such as an image recognition or voice recognition task. In some examples, in determining the performance value of an AI model in fixed point, the process 406 may determine input data, such as test data, and apply the input data to the AI chip to determine the output of the AI chip. The performance value of an AI model (in fixed point) may be inferred by determining the difference between the output of the AI model in fixed point and the output of the corresponding AI model in floating point based on the same test data. In other words, the performance value of an AI model may be indicative of changes of the output since the AI model is converted from floating point to fixed point. The smaller the changes are, the higher the performance value is.

In some scenarios, in determining the performance value of an AI model in fixed point, the output of the AI model may include a feature map of the AI model. The feature map may include the output of the AI model at a given layer. For example, in some scenarios, a CNN model may include multiple convolution layers followed by one or more fully connected layers. In an example implementation, an AI chip may include the multiple convolution layers, whereas the fully connected layers may be implemented in a processing device (e.g., a graphics processing unit, i.e., GPU) outside the AI chip. In such case, the feature map may be selected as the output of the last convolution layer of the AI chip. By comparing the feature map of the AI model in fixed point and the feature map of the AI model in floating point, the performance value can be assessed. For example, the performance value may be based on the correlation of two feature maps. In another example, the performance value may be based on comparing the two feature maps pixel-by-pixel and determining a sum of differences between corresponding pixels in the feature maps.

In some or other scenarios, the output of an AI model may be the final recognition result. In such case, the performance value of the AI model in fixed point is based on the difference between the recognition result from the AI model in floating point and the recognition result from the AI model in fixed point based on the same test data. In some examples, an image recognition result of an AI model may indicate which of the multiple classes a given input image belongs to. In determining the performance value, for each input image in the test data, the classification results are compared and an error (or accuracy value) is calculated based on the difference between the two classification results, and a sum is calculated based on the accuracy values for multiple input images in the test data.

With further reference to FIG. 4, the process 400 may further determine optimal gains for each AI chip at 407. For example, the process 407 may evaluate the performance values as the result of runs of an AI chip during the past iterations and select the gains that result in the best performance values among the iterations. As described herein, the performance value may indicate the difference between the output of the AI model in fixed point and the output of the AI model in floating point. Thus, the smaller the difference is, the higher the performance value is. In this case, a best performance means the highest performance value. For each of the multiple AI chips, respective optimal gains may be determined in the same manner as it is for one AI chip.

Process 400 may repeat for a number iterations until the iteration count has exceeded a threshold T_{c} at 414 and/or the time duration of the process has exceeded a threshold TD at 416. At each iteration, process 400 generates updated gains at 410, and repeating applying the gains to one or more AI chips at 404, determining performance values of the one or more AI chips at 406 and determining optimal gains for each AI chip at 407. For example, G″_{t,0}, G″_{t,1}, . . . , G″_{i,N-1} represent the gains, such as a gain vector for each AI chip 0, 1, 2, . . . N−1, respectively, at ith iteration, where N represents the number of AI chips. In some examples, each AI chip may be coupled to a respective client device. In some examples, multiple AI chips may be coupled together to a client or a host device.

Let A″_{i,0}, A″_{i,1}, . . . , A″_{i,N-1} stand for the performance values of the AI model in fixed point based on the gains applied at box 404 to each AI chip 1 to N at the ith iteration. Then the optimal gain vector may be represented by G_{i-n_op}, where i stands for the current iteration, and n stands for one of the N AI chips, and G_{i-n_op}=U(A_{0.n}″, A_{1.n}″, . . . , A_{i-1.n}″). Function U may include selecting the gains that result in the best performance among the performance values from various iterations immediately preceding the current iteration i. In some examples, a performance value A may include a single value described above indicating the difference between the output of the AI model in fixed point and the output of the corresponding AI model in floating point. U may indicate the highest performance value among the performance values of the AI model in fixed point during all of the previous iterations for an AI chip prior to the current iteration.

With further reference to FIG. 4, the process 400 may further determine global gains at 409 based on the optimal gains from the one or more AI chips. For example, at the ith iteration, the global gains G_{global} may be determined to be one of the G_{i-n_op}'s that has the highest performance value for n=0, . . . N−1, where N is the number of AI chips (such as 206(1), . . . 206(N) in FIG. 2). Alternatively and/or additionally, the process 400 may determine the global optimal gains based on an average of the optimal gains among multiple AI models. In some examples, determining the global gains at 409 may be based on the optimal gains of a subset of AI chips on the network. For example, the process may only analyze top five optimal gains from five AI chips. Alternatively and/or additionally, the process may remove bottom two AI chips in terms of performance values and analyze the optimal gains of the remaining AI chips. At each iteration, process 400 continues to update the global gains at 409 and increments the iteration count at 412. If the iteration count has exceeded the threshold T_{c} at 414 and/or the time duration has exceeded the threshold T_{D} at 416, the process ends at 418. In some scenarios, when the process ends, the global gains are obtained as the final global gains. In some examples, the final global gains may be a gain vector.

In some examples, the process 400 may output the final global gains, to a converter that converts an AI model in floating point to an AI model in fixed point for uploading to an AI chip. In some examples, the global gains may be shared among multiple processing devices on the network, in which any device may use the global gains. An example of a converter is shown as 214 in FIG. 2, and an example process implemented in a converter is shown in FIG. 3 (see box 302). The converted AI model in fixed point may be loaded into an embedded CeNN to be executed to perform recognition tasks based on the converted AI model (see box 310 in FIG. 3). If none of the thresholds have been reached, process 400 repeats applying the updated gains to one or more AI chips at 404.

As described in some examples, gains may be represented by a 1D vector, which contains all of the gains for the one or more AI chips. When gains are represented by a 1D vector, a subtraction of two gain vectors may result in a 1D vector containing multiple gain values, each of which is a subtraction of two corresponding gain values in the two 1D gain vectors, respectively. An addition of two gain vectors may result in a 1D vector containing multiple gain values, each of which is a sum of two corresponding gain values in the two 1D gain vectors. An average of two gain vectors may result in a 1D vector containing multiple gain values, each of which is an average of the corresponding gain values in the two 1 D gain vectors. Similarly, a gain vector may be incremented (added or subtracted) by a perturbation. The resulting gain vector may contain multiple gain values, each of which includes a corresponding gain value in the original gain vector incremented (added or subtracted) by a corresponding value in the perturbation. In some examples, an addition or subtraction of two gain vectors may be in finite field. For example, the addition of gain vectors may be performed in a real coordinate space.

With further reference to FIG. 4, at each iteration, the process 400 may further include generating updated gains at 410. This updates the gains for the one or more AI chips. In other words, the updated gains may include multiple updated gain vectors, each of which may be applied respectively to the one or more AI chips (see box 404) and cause a training process at each AI chip to infer the performance value associated with the updated gain vector. In some examples, at the ith iteration, and for AI chip n, where n=0, 1, . . . N−1 (N is the number of AI chips), the process 400 may maintain the current gains from previous iteration G_{i-1_n}, the optimal gains for an AI chip n, G_{op_n-i}, updated gains G_{i_n} at the current iteration, and the global gains G_{global} across all AI chips. For example, the current gains from previous iteration G_{i-1_n} and updated gains from the current iteration G_{i_n} may be obtained from box 410, and the global optimal gains G_{global} may be obtained from box 409. Process 400 may optimize the training process by adjusting the velocity of the gains.

In some examples, the process may determine a velocity of gains for AI chip n, V_{i_n} at the current iteration i based on the velocity of gains at its previous iteration V_{i-1_n}. The new velocity V_{i_n} may also be determined based on the closeness of the current gains relative to the optimal gains for an AI chip. The new velocity of the gains may also be based on the closeness of the current gains relative to the global gains. The closer the current gains are to the optimal gains and/or the global gains, the lower the velocity of gains for the next iteration may be. For example, a velocity of the gain vector for AI chip n at the current ith iteration may be expressed as:

V_{i_n}=w*V_{i-1_n}+c1*r1*(G_{i-n_op-G}_{i-1_n})+c2*r2*(G_{global}−G_{i-1_n})

where w is the inertial coefficient, c1 and c2 are acceleration coefficients, r1 and r2 are random numbers. In some examples, w may be a constant number selected between [0.8, 1.2], such as 0.9, or other values. Coefficients c1 and c2 may be constant numbers in the range of [0, 2], such as 2.0, or other values. Random numbers r1 and r2 may be generated at each iteration i. The determination of velocity of gains described herein may allow the training process to update the gains at each iteration, moving towards the local optimal AT model (per AI chip) and the global optimal model of the system.

In some examples, gains, such as a G_{i-1_n}, may be a 1D vector containing multiple gain values, for one of the multiple AI chips. A subtraction of two gain vectors, such as G_{global}−G_{i-1_n} may also be a 1D vector containing multiple gain values, each of which is a subtraction of two corresponding gain values in G_{global} and G_{i-1_n}. In some examples, r1 and r2 may be diagonal matrices, for example, n×n matrices, for which each parameter in the column vector corresponds to different randomly-generated values r1 and r2. In some examples, r1 and r2 may be randomly generated and have values between [0, 1]. As such, the training process, such as process 400, becomes an n-dimensional optimization problem. As described herein, the velocity of the gains, e.g., V_{i_n}, V_{i-1_n}, may contain the same number of parameters as that in a gain vector and have the same dimension as the gain vector. Once the velocity V_{i_n} is determined, the process may increment the current gains at the previous iteration by the new velocity to determine updated gains. For example, the updated initial gains for AI chip n may be determined as G_{i_n}=G_{i-1_n}+V_{i_n}. Process 400 may determine the updated gains for all of the AI chips n=0, 1, . . . , N−1 in a similar manner. Upon completion of the process at 418, process 400 may further transmit the global gains to a converter, such as 214 in FIG. 2.

It is appreciated that the disclosures of various embodiments in FIGS. 1-4 may vary. For example, the number of iterations in process 200 in FIG. 2 and the number of iterations in process 400 in FIG. 4 may vary. In a non-limiting example, the number of iterations may be in the range of 100-100000, such as 5000 or other values. In a non-limiting example, the number of AI chips N may vary. The number of AI chips may also be one. In some examples, a single AI chip may be used to implement the various embodiments described in FIGS. 1-4. For example, the processes described in FIGS. 2-4 with implementation of multiple AI chips in parallel may be implemented sequentially in a single AI chip. In such case, the time for implementing the processes in FIGS. 2-4 in a single AI chip may be N times in comparison to using N AI chips.

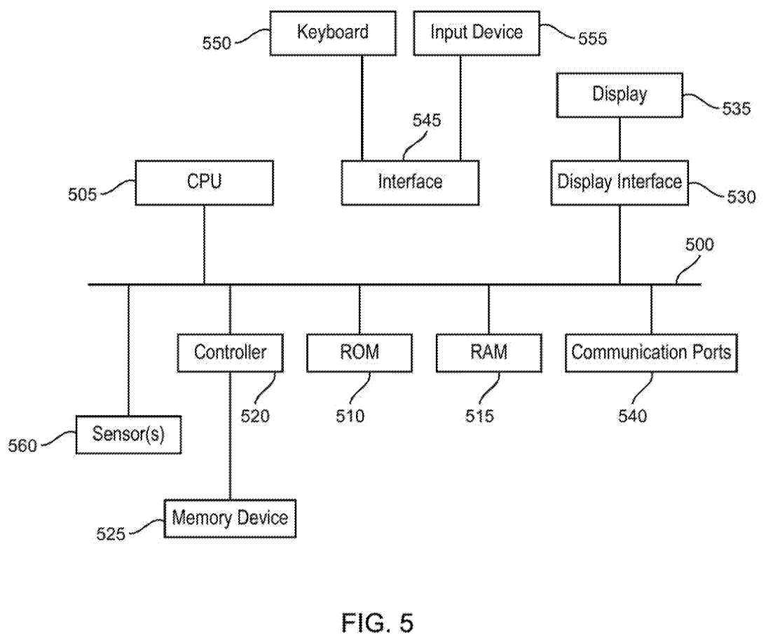

FIG. 5 depicts an example of internal hardware that may be included in any electronic device or computing system for implementing various methods in the embodiments described in FIGS. 1-4. An electrical bus 500 serves as an information highway interconnecting the other illustrated components of the hardware. Processor 505 is a central processing device of the system, configured to perform calculations and logic operations required to execute programming instructions. As used in this document and in the claims, the terms “processor” and “processing device” may refer to a single processor or any number of processors in a set of processors that collectively perform a process, whether a central processing unit (CPU) or a graphics processing unit (GPU) or a combination of the two. Read only memory (ROM), random access memory (RAM), flash memory, hard drives, and other devices capable of storing electronic data constitute examples of memory devices 525. A memory device, also referred to as a computer-readable medium, may include a single device or a collection of devices across which data and/or instructions are stored.

An optional display interface 530 may permit information from the bus 500 to be displayed on a display device 535 in visual, graphic, or alphanumeric format. An audio interface and audio output (such as a speaker) also may be provided. Communication with external devices may occur using various communication ports 540 such as a transmitter and/or receiver, antenna, an RFID tag and/or short-range, or near-field communication circuitry. A communication port 540 may be attached to a communications network, such as the Internet, a local area network, or a cellular telephone data network.

The hardware may also include a user interface sensor 545 that allows for receipt of data from input devices 550 such as a keyboard, a mouse, a joystick, a touchscreen, a remote control, a pointing device, a video input device, and/or an audio input device, such as a microphone. Digital image frames may also be received from an imaging capturing device 555 such as a video or camera that can either be built-in or external to the system. Other environmental sensors 560, such as a GPS system and/or a temperature sensor, may be installed on system and communicatively accessible by the processor 505, either directly or via the communication ports 540. The communication ports 540 may also communicate with the AI chip to upload or retrieve data to/from the chip. For example, the global optimal AI model may be shared by all of the processing devices on the network. Any device on the network may receive the global AI model from the network and upload the global AI model, e.g., CNN weights, to the AI chip via the communication port 540 and an SDK (software development kit). Additionally, and/or alternatively, a device on the network may receive a global gains, e.g., a gain vector, and a global AI model, both of which may be obtained via one or more training processes. The device may convert the global AI model to an AI model in fixed point by applying the global gains. The communication port 540 may also communicate with any other interface circuit or device that is designed for communicating with an integrated circuit.

Optionally, the hardware may not need to include a memory, but instead programming instructions are run on one or more virtual machines or one or more containers on a cloud. For example, the various methods illustrated above may be implemented by a server on a cloud that includes multiple virtual machines, each virtual machine having an operating system, a virtual disk, virtual network and applications, and the programming instructions fbr implementing various functions in the robotic system may be stored on one or more of those virtual machines on the cloud.

Various embodiments described above may be implemented and adapted to various applications. For example, the AI chip having a CeNN architecture may be residing in an electronic mobile device. The electronic mobile device may use the built-in AI chip to produce recognition results and generate performance values. In some scenarios, obtaining the CNN can be done in the mobile device itself, where the mobile device retrieves test data from a dataset and uses the built-in AI chip to perform the training. In other scenarios, the processing device may be a server device in the communication network (e.g., 102 in FIG. 1) or may be on the cloud. These are only examples of applications in which an AI task can be performed in the AI chip.

The various systems and methods disclosed in this patent document provide advantages over the prior art, whether implemented standalone or combined. For example, using the systems and methods described in FIGS. 1-6 may help obtain the global optimal AI model using multiple networked devices in either centralized or decentralized or distributed network. This networked approach helps the system to narrow the search space of the AI model during the training process thus the system may converge to the global optimal AI model faster. The above disclosed embodiments also allow different training methods to be adapted to obtain the global optimal AI model, whether test data dependent or test data independent. For example, a client device may implement its own training process to obtain the local optimal AI model. Above illustrated embodiments are described in the context of generating a CNN model for an AI chip (physical or virtual), but can also be applied to various other applications. For example, the current solution is not limited to implementing the CNN but can also be applied to other algorithms or architectures inside an AI chip.

It will be readily understood that the components of the present solution as generally described herein and illustrated in the appended figures could be arranged and designed in a wide variety of different configurations. Thus, the following more detailed description of various implementations, as represented in the figures, is not intended to limit the scope of the present disclosure, but is merely representative of various implementations. While the various aspects of the present solution are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present solution should be or are in any single embodiment thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages, and characteristics of the present solution may be combined in any suitable manner in one or more embodiments. One ordinarily skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Other advantages can be apparent to those skilled in the art from the foregoing specification. Accordingly, it will be recognized by those skilled in the art that changes, modifications, or combinations may be made to the above-described embodiments without departing from the broad inventive concepts of the invention. It should therefore be understood that the present solution is not limited to the particular embodiments described herein, but is intended to include all changes, modifications, and all combinations of various embodiments that are within the scope and spirit of the invention as defined in the claims.

We claim:

1. A system comprising:
one or more artificial intelligence (AI) chips; and
a processing device communicatively coupled to the one or more AI chips and configured to:
(i) determine a respective gain vector for each of the one or more AI chips;
(ii) determine a first AI model in floating point;
(iii) determine a respective AI model in fixed point for each of the one or more AI chips by applying the respective gain vector to the first AI model;
(iv) upload the respective AI model in fixed point to a corresponding AI chip of the one or more AI chips to determine a performance value associated with the corresponding AI chip; and
(v) determine a global gain vector that results in a best performance value among the performance values of the one or mote AI chips.

2. The system of claim 1, wherein the processing device is further configured to:
repeat (iii)-(v) for a number of iterations; and
additionally, in each iteration:
for each AI chip of the one or more AI chips, update the respective gain vector based on a respective gain vector at a preceding iteration and a velocity of gain for the AI chip.

3. The system of claim 2, wherein the processing device is further configured to, in each iteration:
determine a respective optimal gain vector for each of the one or more AI chips, wherein the respective optimal gain vector results in a best performance value among the performance values of the corresponding AI chip in one or more preceding iterations; and
determine the global gain vector based on the respective optimal gain vectors for the one or more AI chips.

4. The system of claim 3, wherein the velocity of gain for the AI chip is based on at least one of (1) a closeness of the respective previous gain vector relative to the respective optimal gain vector; and (2) a closeness of the respective previous gain vector relative to the global gain vector.

5. The system of claim 3, wherein the performance value of an AI chip is based on a comparison of a feature map of an AI model in foaling point and a feature map of a converted AI model in fixed point.

6. The system of claim 1, wherein:
each of the first AI model and the respective AI models in fixed point includes a convolution neural network (CNN) model containing multiple convolution layers; and
each of the respective gain vectors and the global gain vector comprises a vector containing multiple gain values, wherein a number of gain values in the vector equals a number of convolution layers in the multiple convolution layers.

7. The system of claim 2, wherein the processing device is further configured to, upon a completion of the number of iterations:
convert the first AI model to a second AI model in fixed point by applying the global gain vector to the first AI model, wherein the second AI model is loadable into a physical AI chip coupled to a sensor and configured to:
receive data captured from the sensor; and
perform an AI task based on the captured data and the second AI model loaded in the physical AI chip.

8. The system of claim 7, wherein the processing device is configured to convert the first AI model in floating point to the second AI model in fixed point by:
updating weights of the first AI model in floating point by multiplying the global gain vector thereto;
quantizing the updated weights to generate the second AI model in fixed point.

9. The system of claim 8, wherein:
each of the first AI model in floating point and the second AI model in fixed point includes a convolution neural network (CNN) model containing multiple convolution layers;
the global gain vector contains multiple gain values, wherein a number of gain values in the global gain vector equals a number of convolution layers in the multiple convolution layers; and
the processing device is configured to update the weights of the first AI model by multiplying each of the gain values in the gain vector to weights of a corresponding convolution layer of the CNN model.

10. The system of claim 1, wherein the processing device is configured to determine live respective gain vector to each of the one or more AI chips by assigning one or more random numbers to the respective gain vector.

11. A method for obtaining a global gain vector comprising, by a processing device:
(i) determining a respective gain vector to each of one or more AI chips;
(ii) determining a first AI model in floating point;
(iii) determining a respective AI model in fixed point for each of the one or more AI chips by applying the respective gain vector to the first AI model;
(iv) uploading the respective AI model in fixed point to each of the one or more AI chips to determine a respective performance value; and
(v) determining the global gain vector that results in a best performance value among the performance values of the one or more AI chips.

12. The method of claim 11 further comprising,
repeating steps (iii)-(v) for a number of iterations; and
additionally, in each iteration;
for each AI chip of the one or more AI chips, updating the respective gain vector based on a respective gain vector at a preceding iteration and a velocity of gain for the AI chip.

13. The method of claim 12 further comprising, in each iteration:
determining a respective optimal gain vector for each of the one or more AI chips, wherein the respective optimal gain vector results in a best performance value among the performance values of the corresponding AI chip in one or more preceding iterations; and
determining the global gain vector based on the respective optimal gain vectors for the one or more AI chips.

14. The method of claim 13, wherein the velocity of gain for the AI chip is based on at least one of (1) a closeness of the respective previous gain vector relative to the respective optimal gain vector; and (2) a closeness of the respective previous gain vector relative to the global gain vector.

15. The method of claim 13, wherein the performance value of an AI chip is based on a comparison of a feature map of an AI model in floating point and a feature map of a converted AI model in fixed point.

16. The method of claim 11, wherein:
each of the first AI model and the respective AI models in fixed point includes a convolution neural network (CNN) model that includes multiple convolution layers; and
each of the respective gain vectors and the global gain vector includes vector containing gain values, wherein a number of gain values in the vector equals a number of convolution layers in the multiple convolution layers.

17. The method of claim 12 further comprising, upon a completion of the number of iterations:
converting the first AI model to a second AI model in fixed point by applying the global gain vector to the first AI model; and
loading the second AI model to a physical AI chip coupled to a sensor and configured to:
receive data captured from the sensor; and
perform an AI task based on the captured data and the second AI model loaded in the physical AI chip.

18. The method of claim 17, wherein converting the first AI model in floating point to the second AI model in fixed point comprises:
updating weights of the first AI model in floating point by multiplying the global gain vector thereto;
quantizing the updated weights to generate the second AI model in fixed point.

19. The method of claim 18, wherein:
each of the first AI model in floating point and the second AI model in fixed point includes a convolution neural network (CNN) model containing multiple convolution layers;
the global gain vector includes multiple gain values, wherein a number of gain values in the global gain vector equals a number of convolution layers in the multiple convolution layers; and
updating the weights of the first AI model comprises multiplying each of the gain values in the gain vector to weights of a corresponding convolution layer of the CNN model.

20. The method of claim 11, wherein determining the respective gain vector to each of the one or more AI chips comprises assigning one or more random numbers to the respective gain vector.
